(19) United States
(12) Patent Application Publication
(10) Pub. No.: US 2018/0362264 A1
(43) Pub. Date: Dec. 20, 2018

(54) TRAIN BULK CARGO LOADING SYSTEM HAVING DISCONNECTED RAILROAD TRACK SCALE

(71) Applicant: SHENZHEN ANSHUN ENERGY-SAVING TECHNOLOGY DEVELOPMENT CO., LTD., Shenzhen (CN)

(72) Inventors: Quanwen XIA, Shenzhen (CN); Tonghui AN, Shenzhen (CN); Kai JIA, Shenzhen (CN); Pu HUANG, Shenzhen (CN); Chengying LIU, Shenzhen (CN)

(21) Appl. No.: 16/122,816

(22) Filed: Sep. 5, 2018

Related U.S. Application Data
(63) Continuation of application No. PCT/CN2016/098625, filed on Sep. 9, 2016.

(30) Foreign Application Priority Data
Mar. 9, 2016 (CN) 201610131228.3
Mar. 9, 2016 (CN) 201620176465.7

(51) Int. Cl. B65G 43/08; B65G 69/04; B65G 67/06; B65G 67/08; B65G 65/44

(52) U.S. Cl. CPC B65G 43/08; B65G 69/045; B65G 67/06; B65G 2814/0344; B65G 65/44; B65G 2201/04; B65G 67/08

(57) ABSTRACT

A train bulk cargo loading system having a disconnected railroad track scale, includes a disconnected railroad track scale (1), a tractor (2), a lifting scraping plow (4), a controllable vibration charging hopper (6), a surge bin (8), a belt conveyor (9) and a control terminal (7). The train bulk cargo loading system having the disconnected railroad track scale has a low overall height and a small footprint, thus reducing the construction and production costs. The system integrates loading, trimming, measuring and data sharing, and features uniform loading, balanced train wheel pressure, and accurate measuring. Thus, huge human and material resources consumption caused by uneven loading of an original loading system, large wheel pressure deviation and secondary trimming and measuring required by the railway department may be avoided, significantly reducing the construction cost and operation cost.

### CROSS-REFERENCE TO RELATED APPLICATIONS

This application is a continuation of International Application No. PCT/CN2016/098625 with a filing date of Sep. 9, 2016, designating the United States, now pending, and further claims to Chinese application No. 201610131228.3 with a filing date of Mar. 9, 2017 and Chinese application No. 201620176465.7 with a filing date of Mar. 9, 2017. The content of the aforementioned applications, including any intervening amendments thereto, are incorporated herein by reference.

### TECHNICAL FIELD

The disclosure relates to a bulk cargo loading and measuring system of a train, in particular to a train bulk cargo loading system having a disconnected railroad track scale.

### BACKGROUND

At present, loading systems in a train freight yard mostly adopt a “quantitative bin loading station”, which mainly includes a belt conveyor, a surge bin, a quantitative measuring bin, a loading leakage pipe, a train tractor, a driver's control room, etc. During charging, bulk material is first conveyed to the surge bin by the belt conveyor, and then to the quantitative bin for weighing through a dropping gate of the surge bin. After the bulk material reaches a quantitative level, the dropping gate of the surge bin is closed, a discharging gate of the quantitative bin is opened, and the bulk material is loaded into a loading leakage pipe for loading. Then, the driver manually controls a gate of the loading leakage pipe and a traveling speed of the train tractor to load the bulk material into train carriages from the loading leakage pipe.

Due to the manual control of the whole loading process, the driver has to manually control the speed of pulling the vehicle while manually controlling the gate of the loading leakage pipe, thus there is a reaction time difference, resulting in extremely uneven loading of the same train. In addition, the bulk material with high water content has a high viscosity and is thus easy to stick to the wall of the quantitative bin and the loading leakage pipe when loading. Upon loading the next time, the bulk material will fall into the wagons to varying degrees, resulting in “underweight” or “overweight” of a single wagon. Thus, the wheel pressure of the train will vary greatly, and the maximum wheel pressure will often exceed the carrying capacity of the track. In addition, the traditional “quantitative bin loading station” can only provide a net weight of the materials instead of a total weight of the train wagons required by the railway department. In order to ensure the safe operation of railway lines, the railway department refuses to approve the measurement data of such loading plan. The loading party had to build additional measurement facilities in different places to carry out secondary weighing measurement, manual trimming and loading and unloading operations, which affects the loading efficiency, increases the construction investment of the enterprise's loading and measuring production lines, and increases the cost of loading operations.

At present, a large number of “quantitative bin loading station” bulk cargo loading station weighing systems are used, and the actual loading productivity is only 40-50% of the design efficiency. In addition, due to the use of the surge bin, weighing bin and loading leakage pipe for material dropping layer by layer, the height of material lifting and loading station has been greatly increased, and the vertical height of the loading station is designed to be as high as more than 40 meters, resulting in waste of energy and increased floor space for construction. In addition, off-site weighing has increased the floor area. Finally, the loading and weighing system is high in total cost and production cost but low in efficiency.

### SUMMARY

The disclosure provides a train bulk cargo loading system having a disconnected railroad track scale. The system reduces the links of off-site weighing and loading/unloading of a cargo train, reduces the floor area of a whole loading production line, greatly lowers the height of a loading station, thereby reducing the energy consumption, improving the operation efficiency, and reducing the manufacturing and the production cost of the entire loading system.

A train bulk cargo loading system having a disconnected railroad track scale is achieved through the following technical solution. The train bulk cargo loading system having a disconnected railroad track scale includes a disconnected railroad track scale, a tractor, a lifting scraping plow, a controllable vibration charging hopper, a surge bin, a belt conveyor and a control terminal. The disconnected railroad track scale is mounted on a rail line below a loading station, and the controllable vibration charging hopper is mounted at a lower part of the surge bin. The lifting scraping plow performs trimming after the cargo train is loaded.

As a preferred technical solution, the control terminal of the system is configured to communicate with the railroad track scale in real time.

As a preferred technical solution, the control terminal is configured to collect and transmit data to a background for sharing.

During loading operation, the control terminal communicates with the scale in real time, controls a travelling speed of the train, an opening angle of a gate of the charging hopper, and a height of the lifting scraping plow in a linkage way. Operation parameters are adjusted timely through dynamic measurement data to ensure uniform loading, balanced wheel pressure of the train. And finally the multiple procedures of measuring, loading and trimming are completed in one step, thus reducing the production cost.

The disclosure has the following beneficial effects: the train bulk cargo loading system having the disconnected railroad track scale removes the quantitative bin, the loading leakage pipe, etc. of the original traditional quantitative bin loading station, thus greatly reducing the height of the whole loading station, saving energy and reducing consumption. The floor area of the entire loading production line, the land use cost, and the cost of loading and measuring facilities are reduced. Measuring, loading and trimming are completed simultaneously, thus reducing secondary trimming and measuring, improving production efficiency, and reducing total production cost. Measurement data are shared, multiple measurement links in the entire material supply chain are reduced, and the total cost of the entire supply chain is lowered.

### BRIEF DESCRIPTION OF THE DRAWINGS

In order to more clearly illustrate the embodiments of the present disclosure or the technical solution in the prior art, the drawings required in the embodiments or description of the prior art will be briefly described below. It will be apparent that the drawings in the following description are only some embodiments of the present disclosure. For those of ordinary skill in the art, other drawings can be obtained according to these drawings without creative effort.

FIG. 1 is a schematic diagram of the overall structure of the present disclosure.

### DETAILED DESCRIPTION

All the features disclosed in this specification, or all steps in any method or process disclosed, may be combined in any combination, except combinations where at least some of such features and/or steps are mutually exclusive.

Any feature disclosed in this specification (including any accompanying claims, abstract, and drawings) may be replaced by other equivalent or similar alternative features serving the same purpose, unless specifically stated otherwise. That is, unless specifically stated, each feature disclosed is only one example of a generic series of equivalent or similar features.

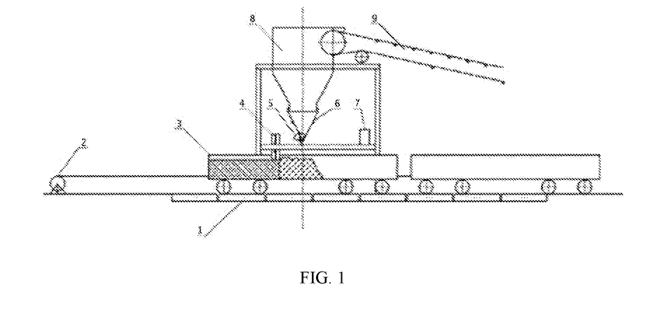

As shown in FIG. 1, a train bulk cargo loading system having a disconnected railroad track scale includes a disconnected railroad track scale 1, a tractor 2, a cargo train 3, a lifting scraping plow 4, a charging hopper gate 5, a vibration charging hopper 6, a control terminal 7, a surge bin 8 and a belt conveyor 9. A plurality of disconnected railroad track scale 1 are mounted on a rail line. A charging hopper gate 5 having a controllable opening/closing gate is provided in a discharge opening of the vibration charging hopper 6. The discharge opening of the vibration charging hopper 6 is mounted at a lower part of the surge bin 8, and the discharge opening is aligned with a longitudinal center line of the cargo train 3. The lifting scraping plow 4 is mounted at the rear of the discharge opening, and the height of the scraping plow is controlled immediately after charging to perform trimming. The belt conveyor 9 is mounted on an upper part of the surge bin 8 to feed the surge bin. The tractor 2 is mounted at a front end of the cargo train 3. The control terminal 7 is mounted at an appropriate position.

The working process of the present disclosure is as follows. During loading operation, the control terminal starts the belt conveyor 9 to feed the surge bin 8. When the surge bin is fed to a set value, the tractor 2 is controlled to be started to pull the cargo train 3 forward. When wheels enter an area of the disconnected railroad track scale, the scale measures the deadweight of a train wagon. When a head of a carriage exceeds the discharge opening, the charging hopper gate 5 is controlled to open, and at the same time a vibrator of the vibration charging hopper 6 is activated to load the bulk material into the carriage. The control system sets a matching traction speed of the tractor 2 according to the weight of the loaded materials of the train through a pre-input program, to continue to pull the cargo train 3 forward, and the height of a head of the lifting scraping plow 4 is adjusted to perform trimming while the cargo train 3 advances. The railroad track scale 4 dynamically detects the measurement data and feeds it back to the control terminal 7 in time. The control terminal 7 calculates and controls an opening angle of the charging hopper gate 5, a travelling speed of the cargo train 3, and the plow head height of the lifting scraping plow 4 according to relevant parameters to ensure a uniform loading of the entire carriage. The total weight, tare weight, net weight and other data are recorded after each carriage is loaded. Because the specific gravity of materials for each shift and batch is different, and the parameters such as the opening angle of the discharging gate, the travelling speed of the cargo train, and the plow head height of the scraping plow are different, the control terminal 7 has an automatic learning and memory function, which records and memorizes the travelling speed of the cargo train, the opening angle of the charging hopper gate, and the plow head height of the scraping plow in real time, and applies them to the next carriage or the next group of trains. In addition, control terminal 7 makes immediate adjustment according to dynamic weighing data of the railroad track scale to ensure uniform loading, accurate measurement and loading efficiency, ensure a final uniform wheel pressure of the train and control the wheel pressure within the allowable range specified by the railway department.

As a preferred technical solution, the data of the control terminal 7 is transmitted to a background. Due to the accurate measurement and uniform loading, the data can be submitted to the government technical supervision department for examination and approval. The measurement data can be shared and used as a reference for cargo delivery and pricing of cargo owners, loading and unloading, transportation, railway and other parties, thus reducing the multiple measurement costs of the entire supply chain.

Compared with the traditional quantitative bin loading station, the train bulk cargo loading system having the disconnected railroad track scale has the following technical and economic characteristics:

1. Great reduction of the overall height and floor area of the loading station, and reduction of the construction investment and operation cost of loading and measuring facilities;

2. Avoidance of secondary loading and unloading, trimming and measuring links, obvious reduction of the labor intensity of loading and unloading workers and lowering of the labor cost;

3. Completion of the measurement, loading and trimming in one step, thus reducing the operation links and improving the production efficiency; and

4. Uniform loading, accurate measurement and sharing of measurement data, which may serve as a reference for the supervision, pricing and settlement of the entire supply chain to reduce multiple measurement links of the entire supply chain, thus reducing the total cost of the entire supply chain.

The above description is only a specific embodiment of the present disclosure, but the protection scope of the present disclosure is not limited thereto, and any changes or substitutions occurring to those skilled in the art without creative effort should be included within the protection scope of the present disclosure. Therefore, the protection scope of the present disclosure should be defined by the claims.

What is claimed is:

1. A train bulk cargo loading system having a disconnected railroad track scale, comprising a disconnected railroad track scale, a tractor, a lifting scraping plow, a controllable vibration charging hopper, a surge bin, a belt conveyor and a control terminal; wherein the disconnected railroad track scale is mounted on a rail line below a loading station; the controllable vibration charging hopper is mounted at a lower part of the surge bin; and the lifting scraping plow is configured for trimming after the cargo train is loaded.

2. The train bulk cargo loading system having the disconnected railroad track scale according to claim 1, wherein the control terminal of the system is configured to communicate with the railroad track scale in real time.

3. The train bulk cargo loading system having the disconnected railroad track scale according to claim 1, wherein the control terminal is configured to collect and transmit data to a background for sharing.
